(19) United States
(12) Patent Application Publication
(10) Pub. No.: US 2024/0295883 A1
(43) Pub. Date: Sep. 5, 2024

(54) OPERATION MANAGEMENT SYSTEM

(71) Applicants: TOYOTA JIDOSHA KABUSHIKI KAISHA, Toyota-shi (JP); KOMATSU LTD., Tokyo (JP)

(72) Inventors: Takahiro OKANO, Chiryu-shi (JP); Toru TAKASHIMA, Susono-shi (JP); Yusuke NOZAWA, Atsugi-shi (JP); Shun MIZOO, Zama-shi (JP); Takashi HIRANAKA, Tokyo (JP); Kenta OSAGAWA, Tokyo (JP); Shota KONISHI, Tokyo (JP)

(73) Assignees: TOYOTA JIDOSHA KABUSHIKI KAISHA, Toyota-shi (JP); KOMATSU LTD., Tokyo (JP)

(21) Appl. No.: 18/590,191

(22) Filed: Feb. 28, 2024

(30) Foreign Application Priority Data
Mar. 3, 2023 (JP) 2023-032574

(51) Int. Cl. G05D 1/65; G05D 1/246; G05D 101/00; G05D 111/10; G05D 111/30; G06Q 50/08

(52) U.S. Cl. CPC G05D 1/65; G05D 1/2462; G06Q 50/08; G05D 2101/22; G05D 2111/17; G05D 2111/30

(57) ABSTRACT

An operation management system including a computer configured to manage operations of registered mobilities. The computer stores road surface information in association with a position in map data based on at least a detection result of a surroundings monitoring device and positional information received from a measurement mobility. The computer stores, as a detail detection area, at least one of a poor detection area in the map data in which detection of the road surface information by the measurement mobility is poor and a predetermined area in the map data. The computer transmits, to the measurement mobility that is scheduled to travel or that is traveling the detail detection area, a speed change command, such that the measurement mobility, which travels at a normal command speed by automated driving, travels the detail detection area at a specific speed lower than the normal command speed.

### REFERENCE TO RELATED APPLICATIONS

This application claims priority from Japanese Patent Application No. 2023-032574 filed on Mar. 3, 2023. The entire content of the priority application is incorporated herein by reference.

### BACKGROUND ART

The present disclosure relates to an operation management system for managing operations of a plurality of registered mobilities.

A road surface condition estimating device is disclosed in Japanese Patent Application Publication No. 2020-013537, for instance, as a device for estimating a condition of a road surface on which a vehicle travels. In the disclosed road surface condition estimating device, an abnormality condition is determined based on a specific behavior that is assumed as a behavior taken by the vehicle when the vehicle encounters an abnormality of the road surface. The road surface condition estimating device obtains behavior information from a plurality of vehicles, determines based on the behavior information whether the abnormality condition is satisfied, and estimates the road surface condition based on the determination result.

### SUMMARY

The device described above estimates the road surface condition based on the behavior of the vehicle. It is accordingly difficult to accurately detect the road surface condition when there is an area for which it is desired to accurately detect the road surface condition. Accordingly, there remains a room for an improvement in this respect.

Accordingly, one aspect of the present disclosure relates to an operation management system capable of increasing detection accuracy of the road surface condition in an area where it is desired to increase the detection accuracy of the road surface condition.

In one aspect of the present disclosure, an operation management system includes a computer configured to manage operations of each of a plurality of registered mobilities by transmission of a command. Each of the plurality of registered mobilities is capable of obtaining positional information thereof. One or more of the plurality of registered mobilities are stored in the computer each as a measurement mobility. Each of the one or more of the registered mobilities is set in advance and includes a surroundings monitoring device configured to detect information on a surrounding object. The computer stores road surface information in association with a position in map data based on at least a detection result of the surroundings monitoring device and the positional information received from the measurement mobility. The computer stores, as a detail detection area, i) a poor detection area in the map data in which detection of the road surface information by the measurement mobility is poor, ii) a predetermined area in the map data, or iii) the poor detection area and the predetermined area. The computer transmits, to the measurement mobility that is scheduled to travel the detail detection area or that is traveling the detail detection area, a speed change command that is the command relating to a speed change, such that the measurement mobility, which travels at a normal command speed by automated driving, travels the detail detection area at a specific speed lower than the normal command speed.

According to the present disclosure, the measurement mobility travels the detail detection area at the specific speed lower than the normal command speed, based on the speed change command transmitted from the computer. The traveling speed of the measurement mobility is lowered, so that a recognition time of the surroundings monitoring device is increased and shaking of the mobility due to unevenness of the road surface is suppressed. This configuration enhances the accuracy of detection of the road surface in the detail detection area by the surroundings monitoring device. Thus, the operation management system according to the present disclosure can increase the detection accuracy of the road surface condition in the area for which it is desired to increase the detection accuracy of the road surface condition.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which:

FIG. 1 is a view illustrating a configuration of an operation management system according to one embodiment of the present disclosure;

FIG. 2 is a flowchart illustrating processing in the embodiment; and

FIG. 3 is a conceptual view for explaining one example of processing in the embodiment.

### DESCRIPTION

Referring to the drawings, there will be hereinafter described in detail an operation management system 1 according to one embodiment of the present disclosure. It is to be understood that the present disclosure is not limited to the details of the following embodiment but may be changed and modified based on the knowledge of those skilled in the art. In the present embodiment, there will be explained the operation management system 1 used in a situation in which there are many unpaved roads such as in mines.

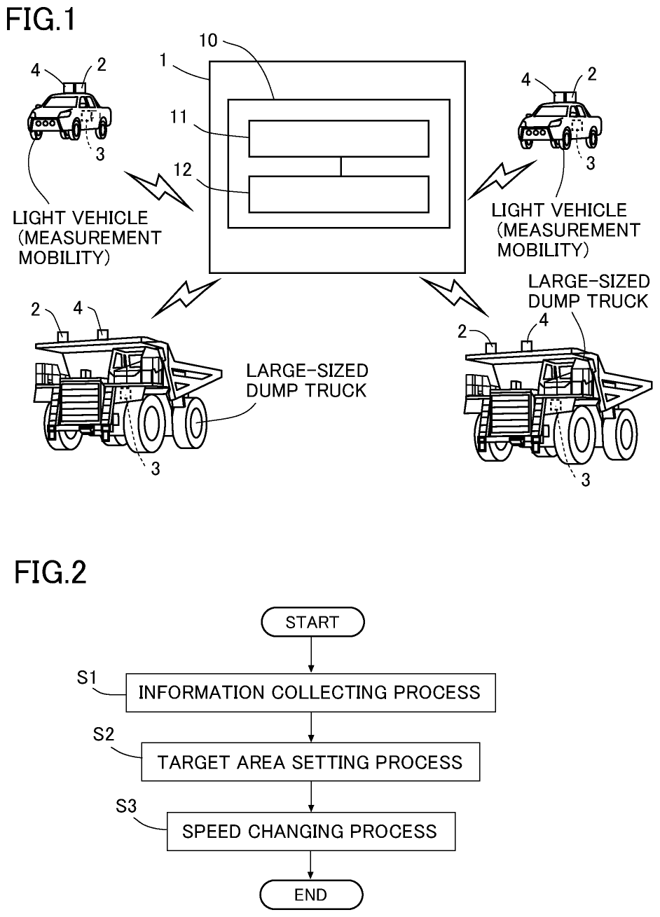

As illustrated in FIG. 1, the operation management system 1 includes a computer 10 configured to manage operations of each of a plurality of registered mobilities by transmission of a command. Each of the plurality of registered mobilities is capable of obtaining positional information thereof. The registered mobility is a mobility registered beforehand in the computer 10 as a target to be managed. The mobility is a movable body (such as a vehicle) that travels on a road surface. Each registered mobility includes, for instance, a receiver 4 of a global navigation satellite system (GNSS) and an automated driving ECU 3 configured to execute an automated driving control.

In the present embodiment, a plurality of light vehicles and a plurality of large-sized dump trucks (large-sized heavy equipment) are registered each as the registered mobility. The light vehicle is a pickup truck, for instance. The computer 10 manages operations of the plurality of registered mobilities including the mobilities that are different in kind or type. The computer 10 is communicable with each registered mobility. The operation management system 1 may be referred to as a central control system and is disposed in a facility including a wireless communication device.

The computer 10 of the operation management system 1 includes at least one processor 11 and at least one memory 12. The processor 11 executes various kinds of processing according to programs stored in the memory 12. The memory 12 may be disposed inside or outside the computer 10. It can be said that the computer 10 includes an electronic control unit (ECU).

The computer 10 stores map data. The computer 10 calculates a target route of each registered mobility based on the map data, a destination location of each registered mobility, and a position (current location) of each registered mobility. The computer 10 transmits, to each registered mobility, information about the target route and a traveling condition as a command (that may be referred to as an instruction, a command signal, or an instruction signal). The traveling condition includes a traveling speed. The computer 10 transmits, to the registered mobility for which automated driving is performed, a “normal command speed” as the command. The normal command speed is set as the traveling speed in automated driving. The traveling condition further includes information about a traveling interval (vehicle-to-vehicle distance). Based on the command received from the computer 10, the automated driving ECU 3 of each registered mobility executes an automated driving control with respect to a steering device, a drive device, and a brake device (each of which is not illustrated).

A plurality of (one or more) registered mobilities are stored (registered) in the computer 10 each as a “measurement mobility”. Each of the one or more of the registered mobilities is set in advance and includes a surroundings monitoring device 2 configured to detect information on a surrounding object. The surroundings monitoring device 2 includes at least one of a camera, a light detection and ranging or laser imaging detection and ranging (LiDAR) device, and a radar. Each of the camera, the LiDAR device, and the radar detects information on the surrounding object. In the present embodiment, the surroundings monitoring device 2 is installed on each of the plurality of registered mobilities. For instance, a plurality of cameras, one LiDAR device, and a plurality of millimeter-wave radars are installed as the surroundings monitoring device 2 on each light vehicle of the present embodiment. The automated driving ECU 3 of each registered mobility can finely adjust the target route based on a detection result of the surroundings monitoring device 2 and the map data. For instance, the automated driving ECU 3 adjusts the target route so as to avoid an obstacle. It can be said that the surroundings monitoring device 2 is constituted so as to include a device that includes a recognition sensor such as the camera and/or that utilizes a time of flight (ToF) technique.

In the computer 10 of the present embodiment, a plurality of light vehicles is stored each as the measurement mobility. The measurement mobility is set as the mobility that detects the road surface condition during traveling. The detection accuracy of the road surface condition is higher in the light vehicle than in the large-sized dump truck because of the position at which the surroundings monitoring device 2 is disposed in the mobility. Further, the light vehicle has a relatively high degree of freedom in traveling and is suitable for detecting the road surface condition. It is noted that the measurement mobility may be one mobility or may be the mobilities in plural kinds.

The computer 10 stores the road surface information in association with a position in map data based on at least the detection result of the surroundings monitoring device 2 and the positional information received from the measurement mobility. This process may be referred to as an information collecting process. Each measurement mobility transmits, to the computer 10 (the operation management system 1), the road surface information that is information about the road surface condition detected by the surroundings monitoring device 2. The computer 10 stores the road surface information and the positional information in association with the map data. This enables generation of the map data including the road surface information. In a case where the computer 10 receives the road surface information from the registered mobility other than the measurement mobility, the computer 10 may also store the road surface information in question in association with the map data.

The computer 10 stores, as a detail detection area, at least one of: a poor detection area in the map data in which detection of the road surface information by the measurement mobility is poor; and a predetermined area in the map data. This process may be referred to as a target area setting process. In a case where the road surface information transmitted from the measurement mobility includes the road surface information with low accuracy, the computer 10 sets, as the detail detection area, a traveling area of the measurement mobility corresponding to the low-accurate road surface information. When the surroundings monitoring device 2 detects the road surface condition under a poor detection environment such as in sand dust or backlight, the confidence level of the road surface information at that position is low. When the measurement mobility is traveling in a poor visibility situation, the accuracy of detection of the road surface condition by the surroundings monitoring device 2 is lowered. Further, in a case where the road surface is considerably rough, the surroundings monitoring device 2 of the measurement mobility that travels on the rough road surface considerably shakes, causing a possibility of lowered detection accuracy.

In a case where the received road surface information does not satisfy a predetermined condition, the computer 10 sets the road surface information as poor detection information. In the surroundings monitoring device 2, there is set a range, i.e., a recognizable range, in which the presence or absence of the object and the shape of the object can be recognized (determined) under a normal environment (such as an environment in which no poor detection factors such as sand dust exist). The predetermined condition is that “The presence or absence of the object can be determined in the recognizable range.” and “The shape of the object can be determined when the object is detected.”. For instance, it is determined that the detection result of the surroundings monitoring device 2 is poor when the shape of the object cannot be recognized though the existence of the object can be recognized in the recognizable range or when nothing can be recognized in part of or all of the recognizable range (such as when the road surface located several meters ahead cannot be recognized). The “object” means something that has a shape and refers to animals and the shape of the road surface such as unevenness (protrusions and recesses) or ruts. The predetermined condition can be suitably set. For instance, the predetermined condition may be set as follows using a known index indicative of the confidence level of the detection result (data). Namely, the predetermined condition may be a condition that “The confidence level of the data is not lower than a set value.”.

In the computer 10 of the present embodiment, a “crossroads intersection” is set beforehand as the detail detection area. That is, the detail detection area in the present embodiment includes: a poor detection area in which detection of the road surface condition is poor; and the crossroads intersection. For instance, a range (area) in which the surroundings monitoring device 2 detects the road surface condition of the crossroads intersection corresponds to the detail detection area. The crossroads intersection tends to be rough particularly in an unpaved road (dirt road). Thus, the crossroads intersection is the area where it is desired to detect the road surface condition in detail.

The computer 10 transmits, to the measurement mobility that is scheduled to travel the detail detection area or that is traveling the detail detection area, a speed change command that is a command relating to a speed change, such that the measurement mobility, which travels at the normal command speed by automated driving, travels the detail detection area at a specific speed lower than the normal command speed (the specific speed<the normal command speed). This process may be referred to as a speed changing process. The computer 10 grasps the position and the target route of each measurement mobility. Thus, the computer 10 can determine which measurement mobility is scheduled to travel or is traveling the detail detection area.

For instance, the computer 10 transmits the speed change command to the measurement mobility that is to travel the detail detection area in the future, such that the measurement mobility travels at the specific speed when traveling the detail detection area. That is, the computer 10 transmits a deceleration command to the target measurement mobility. The automated driving ECU 3 of the measurement mobility that receives the speed change command causes the own mobility to decelerate before the own mobility enters the detail detection area, causes the own mobility to enter the detail detection area at the specific speed, and causes the speed to return to the normal command speed when the own mobility gets out of the detail detection area. As illustrated in FIG. 2, the computer 10 is configured to execute an information collecting process S1, a target area setting process S2, and a speed changing process S3.

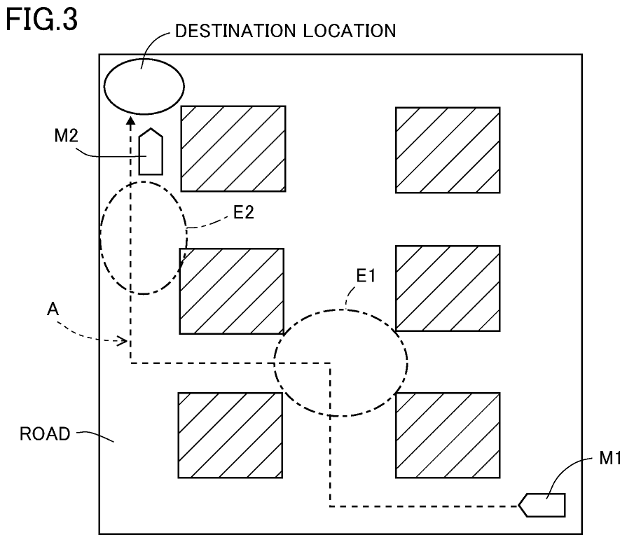

A case in which a measurement mobility M1 is to travel a target route A is explained by way of one example, as illustrated in FIG. 3. In this case, the computer 10 transmits, to the measurement mobility M1, the speed change command relating to traveling at a crossroads intersection E1 in the target route A. When the computer 10 determines that detection of the road surface information in the area E2 in the target route A by a preceding measurement mobility M2 is poor before the measurement mobility M1 travels the area E2, the computer 10 sets the area E2 to the detail detection area and transmits, to the measurement mobility M1, the speed change command relating to the traveling speed in the area E2. In a case where the computer 10 sets the area E2 to the detail detection area when the measurement mobility M1 is traveling the area E2, the computer 10 may transmit the speed change command to the measurement mobility M1 that is traveling the area E2.

When the registered mobility turns to right or left at the crossroads intersection, the registered mobility decelerates even if the crossroads intersection is not the detail detection area. In some cases, the traveling speed when the registered mobility turns to right or left is lower than the specific speed. However, if the speed changing process S3 is executed, a period during which the registered mobility travels at a low speed can be made longer than in normal right or left turning, thus enhancing the detection accuracy with high reliability. The advantage offered by the speed changing process S3 is great in a case where the measurement mobility travels straight the crossroads intersection.

According to the present embodiment, the target measurement mobility travels the detail detection area at the specific speed lower than the normal command speed, based on the speed change command transmitted from the computer 10. The traveling speed of the measurement mobility is lowered, so that the recognition time of the surroundings monitoring device 2 is increased and shaking of the mobility due to unevenness of the road surface is suppressed. This configuration enhances the accuracy of detection of the road surface in the detail detection area by the surroundings monitoring device 2. Thus, the operation management system 1 according to the present disclosure can increase the detection accuracy of the road surface condition in the area for which it is desired to increase the detection accuracy of the road surface condition. The measurement mobility travels at a lowered traveling speed in the area where it is estimated that the road surface tends to be rough and in the area where it is determined beforehand that the reliability of the information to be obtained is low, so that accurate road surface information can be efficiently obtained.

### Execution Condition

In the computer 10 of the present embodiment, one or more conditions (here, a plurality of conditions) are set as a condition for executing the speed changing process S3. One execution condition is set as follows. Namely, “The measurement mobility, to which the speed change command is to be transmitted (hereinafter referred to as a target mobility), arrives at a destination location on or before a target arrival time even if the speed changing process S3 is executed.”. In a case where the target arrival time at the destination location is set for the target mobility, the computer 10 calculates the arrival time of the target mobility based on a departure time, the target route, and the traveling speed. The target arrival time is the latest time acceptable as the arrival time.

The execution condition described above is satisfied if the arrival time of the target mobility when the speed changing process S3 is executed for the target mobility is on or before the target arrival time. The computer 10 may accelerate the departure time of the target mobility to satisfy the execution condition. In a case where the arrival time of the target mobility becomes equal to or earlier than the target arrival time if the speed changing process S3 is executed for only part of the detail detection area, the computer 10 may execute the speed changing process S3 for only the part of the detail detection area. In this instance, the computer 10 may execute, with high priority, the speed changing process S3 for the area where the confidence level of the road surface information is low.

Thus, the computer 10 is configured not to transmit the speed change command to the target mobility when the computer 10 determines in computation that the “target mobility”, which is the measurement mobility to which the speed change command is to be transmitted, arrives at the destination location at a time later than the target arrival time thereof if the target mobility travels the detail detection area at the specific speed. This enables the road surface condition to be detected in detail within a range in which the measurement mobility keeps the target arrival time.

Another execution condition is as follows. Namely, “No delay occurs in the operations of other registered mobilities when the target mobility decelerates by execution of the speed changing process S3.”. The delay means that the arrival time is later than the target arrival time. There is a possibility that a following registered mobility is decelerated by deceleration of the target mobility. Based on information on each of the registered mobilities other than the target mobility (such as the position, the target route, the traveling condition, and the target arrival time), the computer 10 calculates (estimates or simulates) the time of arrival at the destination location of each registered mobility when the speed changing process S3 is executed. Based on the calculation result, the computer 10 determines whether the execution condition described above is satisfied.

Thus, the computer 10 is configured not to transmit the speed change command to the target mobility when the computer 10 determines in computation that even only one of the registered mobilities other than the target mobility arrives at the destination location at a time later than the target arrival time of the one of the registered mobilities if the target mobility travels the detail detection area at the specific speed. Owing to the two execution conditions, the measurement mobility can detect the road surface condition in detail within a range in which all the registered mobilities keep their own target arrival times. That is, the speed changing process S3 does not adversely influence the operations of other registered mobilities.

In addition to the two execution conditions describe above, a condition that “The target mobility is unmanned.” may be added as the execution condition. When the target mobility is traveling in manned automated driving, an occupant of the target mobility may feel unnatural if the speed is changed in the detail detection area. In view of this, the computer 10 may execute the speed changing process S3 only when the target mobility is performing unmanned automated driving. The presence or absence of the occupant can be determined based on notification to the computer 10 by the operation of the occupant or a detection result of a seat sensor installed on a seat, for instance. In a case where the occupant is present in the target mobility, the computer 10 may be configured not to transmit the speed change command to the target mobility. Even in a case where the target mobility is a manned automated driving mobility, it is possible to prevent the occupant from feeling unnatural by making notification of deceleration to the occupant in advance.

### OTHERS

The present disclosure is not limited to the details of the illustrated embodiment. For instance, the surroundings monitoring device 2 may be configured to detect only an object located ahead of the mobility. The operation management system 1 may be constituted by a plurality of computers. The detail detection area is not limited to the crossroads intersection but may be a T-intersection, an area where the registered mobility travels predetermined number of times or more, etc. The operation management system 1 is used in not only mines but also other sites.

What is claimed is:

1. An operation management system including a computer configured to manage operations of each of a plurality of registered mobilities by transmission of a command, each of the plurality of registered mobilities being capable of obtaining positional information thereof,
wherein one or more of the plurality of registered mobilities are stored in the computer each as a measurement mobility, each of the one or more of the registered mobilities being set in advance and including a surroundings monitoring device configured to detect information on a surrounding object,
wherein the computer stores road surface information in association with a position in map data based on at least a detection result of the surroundings monitoring device and the positional information received from the measurement mobility,
wherein the computer stores, as a detail detection area, i) a poor detection area in the map data in which detection of the road surface information by the measurement mobility is poor, ii) a predetermined area in the map data, or iii) the poor detection area and the predetermined area, and
wherein the computer transmits, to the measurement mobility that is scheduled to travel the detail detection area or that is traveling the detail detection area, a speed change command that is the command relating to a speed change, such that the measurement mobility, which travels at a normal command speed by automated driving, travels the detail detection area at a specific speed lower than the normal command speed.

2. The operation management system according to claim 1, wherein the computer does not transmit the speed change command to a target mobility when the computer determines in computation that the target mobility arrives at a destination location at a time later than a target arrival time thereof if the target mobility travels the detail detection area at the specific speed, the target mobility being the measurement mobility to which the speed change command is to be transmitted.

3. The operation management system according to claim 1, wherein the computer does not transmit the speed change command to a target mobility when the computer determines in computation that even only one of the registered mobilities other than the target mobility arrives at a destination location at a time later than a target arrival time of the one of the registered mobilities if the target mobility travels the detail detection area at the specific speed, the target mobility being the measurement mobility to which the speed change command is to be transmitted.

4. The operation management system according to claim 1, wherein the computer does not transmit the speed change command to a target mobility when an occupant is present in the target mobility, the target mobility being the measurement mobility to which the speed change command is to be transmitted.

5. The operation management system according to claim 1, wherein the surroundings monitoring device includes at least one of a camera, a light detection and ranging or laser imaging detection and ranging (LiDAR) device, and a radar.
